(19) United States
(12) Patent Application Publication
(10) Pub. No.: US 2011/0000419 A1
(43) Pub. Date: Jan. 6, 2011

(54) Molepeller

(76) Inventor: John Mark Gauthier, Tecumseh, MI (US)

Correspondence Address: Smart Stuff LLC, 4946 N. Raisin Center Hwy, Tecumseh, Tecumseh, MI, 49286, US

(21) Appl. No.: 12/775,463

(22) Filed: Jun. 11, 2010

Related U.S. Application Data
(60) Provisional application No. 61/270,004, filed on Jul. 2, 2009.

(51) Int. Cl. A01M 29/00

(52) U.S. Cl. 116/22 A

(57) ABSTRACT

The Molepeller uses a propeller assembly constructed of corrugated polypropylene, which makes The Molepeller completely safe while operating. All other known wind-driven mole-deterrent devices use rigid materials to construct their propellers, and are inherently dangerous to persons and pets when spinning.

The Molepeller creates its deterrent noises below the surface of the ground, which is novel among known wind-driven mole-deterrent devices.

The Molepeller's propeller rotates around a vertical axis, which is novel among know wind-driven mole-deterrent devices.

### CROSS REFERENCE TO RELATED APPLICATION

Provisional application No. 61/270,004 (Jul. 14, 2009) EFS application number 12775463 (May 6, 2010)

### STATEMENT REGARDING FEDERALLY SPONSORED RESEARCH OR DEVELOPMENT

No governmental funds were provided in any phase of development of The Molepeller.

### BACKGROUND OF THE INVENTION

Moles are notorious for their destructiveness to lawns and landscapes, and they extremely hard to get rid of. All kinds of remedies have been tried, but all have drawbacks: battery-powered or solar-powered sonic devices, which send off weak signals because of their inherent power constraints; traps, which are cumbersome and difficult to administer; numerous home concoctions, such as human hair or castor beans, which mole experts are quick to refute; poisons and gases which are inhumane; fumigants, which simply evaporate into thin air; and other wind-driven devices, which can be large, obtrusive and dangerous.

### BRIEF SUMMARY OF INVENTION

While The Molepeller was designed with all the weaknesses of other mole-deterrent devices in mind, it was designed chiefly to overcome the danger posed by the propeller assemblies of other wind-driven devices, which, when spinning, can inflict serious injury. It was deemed that such a safe product would have satisfactory commercial potential.

The use of corrugated polypropylene in construction of its propeller assembly is The Molepeller's chief advantage over other wind-driven mole-deterrent devices. A propeller constructed of corrugated polypropylene is lightweight, soft and flexible, and yet maintains structure in high winds; unlike propellers of metal or other hard materials, it is totally safe when spinning (as has been tested), and poses no danger to persons or pets that may come in contact with them.

Additionally, The Molepeller's noise output is stronger and more effective than other devices that deter with noise because, when compared with sonic devices, it is not limited by a power source, and, when compared with other wind-driven devices, its noise originates closer to the pests it seeks to deter. When compared with traps, it is easier to install and move as needed. When compared with other wind-driven devices (which can be large, obtrusive and dangerous), it is small, it is landscape-friendly, and it is entirely safe. When compared with poisons, gases and fumigants, it is more humane because it deters rather than kills.

Corrugated polypropylene is available in many colors, adding to The Molepeller's landscape appeal. Polypropylene is nearly impervious to the ravages of seasonal weather, giving The Molepeller a degree of weatherability not found in other wind-driven mole-deterrent devices. And, a propeller assembly of corrugated polypropylene makes for design simplicity by permitting inline insertion and direct drive of the rod that causes below-ground noise.

### DESCRIPTION OF DRAWING(S) AND INVENTION

FIG. 1 (Drawings, page 1) depicts the entire Molepeller assembly, the components of which are detailed following this descriptive summary of The Molepeller's size, construction and operation.

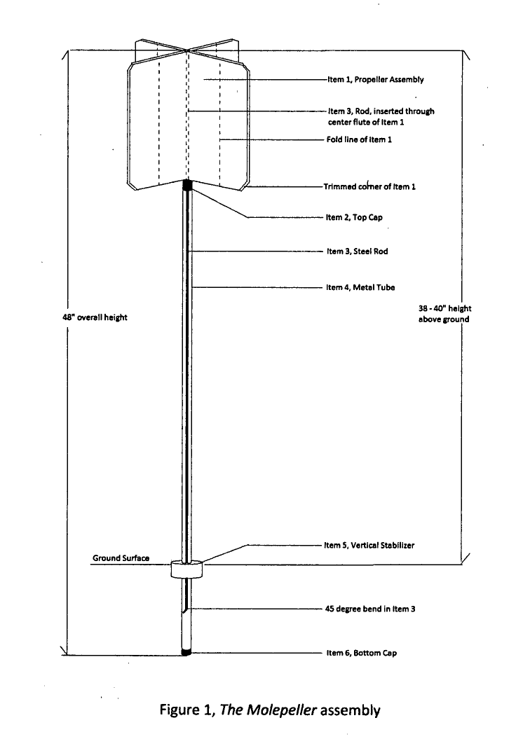

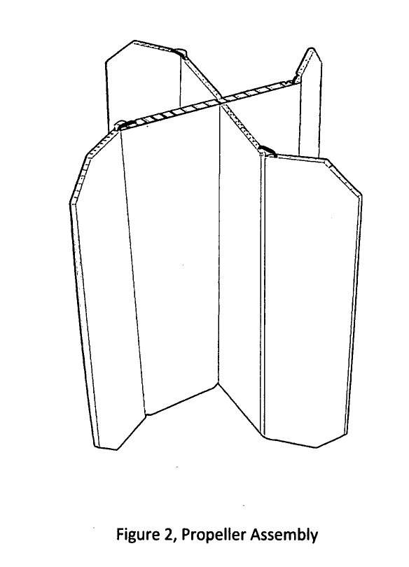

The overall height of The Molepeller is 48″, comprised of an 11-¾″ high corrugated polypropylene propeller assembly (item 1, FIG. 1) atop a 36-¼″ high assembly of a plated steel tube and plastic end caps (items 2, 4, 6, FIG. 1). The total height of 48″ was determined to be ideal, as lower models (36″) failed to capture enough wind to rotate effectively, and higher models (60″) were too costly to ship.

The top of the metal rod (item 3, FIG. 1) is inserted through the entire height of the propeller assembly's center flute by means of press fit, providing no-slip engagement, so that the rod rotates as the propeller assembly rotates. The bottom of the metal rod travels nearly to bottom of the metal tube (Item 4, FIG. 1). The bottom of the metal rod is bent at approximately 45 degrees; as the rod spins it grates and rattles against the metal tube, causing mole and pest deterrent noises. The grating and rattling noises have been demonstrated in practice to be highly effective at chasing away moles and other ground-dwelling animals.

When The Molepeller is buried 8-10″ into the ground (as is depicted in FIG. 1, and as is recommended in operating/installation instructions shipped with units), the rod strikes the tube at a depth near moles' foraging tunnels, allowing The Molepeller's noises to carry long distances below the surface of the ground. The instructions recommend placement of The Molepeller directly into foraging tunnels or into mounds made when moles push dirt from their dens to the surface.

A vertical stabilizer (Item 5, FIG. 1) is provided with each Molepeller, the purpose of which is to keep The Molepeller perpendicular (90 degrees) to the ground's surface, even when the ground has been softened by heavy rain and strong winds push against it.

### Item 1, Propeller Assembly

The Molepeller's propeller is an assembly of two (2) blanks (12″×11-¾″) cut from 4 mm corrugated (fluted) polypropylene plastic sheets of varying colors. When joined as described below, these blanks become the propeller's blades.

The corners of each blank are then trimmed so that there aren't sharp edges that might be hazardous when spinning.

The blanks are prepared for joining by cutting 5-⅞″ slots in the middle of each blank, and two like-angle folds are formed in each blank at flutes at approximately 3″ from each blank's side edge. These folds help the blanks/blades “catch” the wind, and they allow The Molepeller to be shipped in cartons of much smaller girth so as to reduce shipping costs.

The assembled blanks are held firmly together with cured hot-melt adhesive. After all processing, a finished propeller appears as in FIG. 2 (Drawings, page 2).

Four (4) U-shaped pins are supplied with each Molepeller to form and secure the wind-catching angles of each propeller blade.

### Item 2, Top Cap

The top cap is a black vinyl plastic cap with an I.D. equal to the O.D. of the metal tube. A hole is drilled in the top of the cap to allow the metal rod (item 3) to be inserted through the cap and into the metal tube (item 4).

### Item 3, Steel Rod

The metal rod is a 3/16″ O.D. rod of common carbon steel with an overall length of 44″. The top of the rod is press fit into the center flute of the propeller assembly (item 1) so that it passes through the propeller's entire height of 11-¾″ (as shown by the wind paddle's center dotted line in FIG. 1).

The bottom of the metal rod is bent at approximately 45 degrees to allow it to engage the metal tube below the ground's surface, and to grate and rattle against the metal tube (item 4) as wind rotates the propeller and the metal rod.

### Item 4, Metal Tube

The metal tube is made of finished steel, though it may also be made of unfinished aluminum or copper. This device uses a ⅞″ O.D. tube with a 0.047 wall thickness, though ¾″ or 1″ O.D. tubes of similar gauge have been found to be effective as well. The overall length of the tube is 36″.

### Item 5, Vertical Stabilizer

The vertical stabilizer is a molded plastic (PVC) device that holds The Molepeller vertical and perpendicular to the ground's surface when the ground is soft and high winds push against The Molepeller.

### Item 6, Bottom Cap

The bottom cap is a black vinyl plastic cap with an I.D. equal to the O.D. of the metal tube. A hole is drilled in the bottom of the cap to allow water to weep out of the assembly.

1. A claim of invention is made for The Molepeller because its propeller assembly is both novel and non-obvious.
There are other wind-driven mole-deterrent devices, but all known ones suffer the same critical problem: their propeller assemblies are constructed of rigid materials (either metal, hard plastic or wood), which, when spinning, are capable of inflicting serious injury to persons or pets that may come in contact with them. Persons with ordinary skill in the art of designing wind-driven mole-deterrents have neither recognized the need for safer propellers, nor have these persons actually incorporated safer propellers into their wind-driven devices. Recognizing the need for safety among wind-driven products, and understanding the commercial potential of such a product, a propeller design was sought that would yield both safety and landscape appeal.
The Molepeller's propeller assembly is made from soft, flexible, lightweight, colorful corrugated polypropylene. Use of corrugated polypropylene in the construction of The Molepeller's propeller assembly renders significant safety advantages over other wind-driven mole-deterrent devices, and is considered to make The Molepeller novel among wind-driven mole-deterrent devices, and, because there have been no apparent efforts to make safer propellers, use of corrugated polypropylene satisfies the requirement of non-obviousness.
The Molepeller features a spinning metal rod within a stationary metal tube, driven directly by its propeller. Noise created by The Molepeller originates below the surface of the ground, where the spinning rod contacts the stationary tube. Noise created by other know wind-driven mole-deterrent devices originates above the ground, and is then carried or transmitted by secondary means into the ground, with attenuation. Because no other known wind-driven mole-deterrent device is so designed, this feature of The Molepeller's design is novel, and may qualify as non-obvious.
Additionally, the direction of rotation of The Molepeller's propeller assembly is horizontal to the ground, around an axis perpendicular to the ground, whereas the direction of rotation of propellers of known wind-driven mole-deterrent devices is perpendicular to the ground, around axes horizontal to the ground. This characteristic of directional rotation allows for design simplicity, appears to be novel among known wind-driven mole-deterrent devices, and may also qualify as non-obvious.
